(19) United States
(12) Patent Application Publication
(10) Pub. No.: US 2024/0201841 A1
(43) Pub. Date: Jun. 20, 2024

(54) SYSTEMS AND METHODS FOR INTERACTIVE COLOR SELECTION WITH DYNAMIC COLOR CHANGING LEDS

(71) Applicant: SIGNIFY HOLDING B.V., EINDHOVEN (NL)

(72) Inventors: LAURA ELLEN CUNNINGHAM, BUCKLAND, MA (US); ROHIT KUMAR, ACTON, MA (US); DONG HAN, NEWTON, MA (US); THARAKESAVULU VANGALAPAT, QUINCY, MA (US)

(21) Appl. No.: 18/555,887

(22) PCT Filed: Apr. 11, 2022
(86) PCT No.: PCT/EP2022/059661

§ 371 Date: Oct. 18, 2023

Related U.S. Application Data
(60) Provisional application No. 63/176,394, filed on Apr. 19, 2021.

(30) Foreign Application Priority Data
Apr. 29, 2021 (EP) 21171233.6

(51) Int. Cl. G06F 3/04883; G06F 3/041; G06F 3/04847; H05B 45/20

(52) U.S. Cl. CPC G06F 3/04883; G06F 3/0412; G06F 3/04847; H05B 45/20; G06F 2203/04104; G06F 2203/04808

(57) ABSTRACT

A system for color selection is provided, including a gesture receiver, a color generator, a color mixer, a user interface, and a touchscreen. The gesture receiver receives a first touch point from the user interface via a touchscreen, the first touch point having a first initial location and a first current location. The color generator then generates a first color, either randomly or based on the first initial location. The gesture receiver then receives a second touch point from the user interface via the touchscreen, the second touch point having a second initial location and a second current location. The color generator then generates a second color based on the first color and a color optimizer. The color mixer then generates a mixed color based on the first color, the second color, the first initial location, the first current location, the second initial location, and the second current location.

### FIELD OF THE DISCLOSURE

The present disclosure is directed generally to systems and methods for color selection, and more particularly, to systems and methods for interactive color section with dynamic color changing light emitting diodes (LEDs).

### BACKGROUND

Dynamic color changing LEDs are often used to light buildings, façades, bridges, and monuments. These public structures may implement interactive lighting systems to allow members of the public to control various aspects of the lighting systems, including color selection. The most common method of color selection involves a color palette or color wheel. The color palette or color wheel may be configured to display a wide-array of different colors, and allow a user to choose the color of the lighting system by simply selecting a single color from the pallet or wheel. However, such a system is rather deterministic, and may be lacking in terms of user entertainment and discovery, thus reducing user engagement. Accordingly, there is a need for a color selection system which improves user engagement by incorporating aspects of entertainment and discovery, while still allowing the user a degree of control in selecting the color scheme of the interactive lighting system.

### SUMMARY OF THE DISCLOSURE

The present disclosure is directed generally to systems and methods for color selection. The user begins the color selection process by touching a user interface with one of their fingers, such as their thumb. The system generates a first color, which is displayed on the user interface. The first color can be generated randomly, or it can be generated based on the location of the thumb touch point. The first color can be displayed in the user interface, such as about the thumb touch point or in a background portion of the user interface. The user may adjust the intensity of the chosen color by the amount of pressure applied to the thumb touch point, and these intensity adjustments can be reflected in the display of the first color. The user may generate an entirely different first color by lifting their thumb from the user interface, and touching the user interface a second time.

The user continues the color selection process by touching the user interface with a second finger, such as their index finger, while their first finger remains in contact with the user interface. The system generates a second color based on a color optimizer. The color optimizer chooses the second color such that it would be a maximum distance from the first color on a virtual color wheel. The user may generate a different second color by lifting their index finger from the user interface, and touching the user interface a second time. The new second color will be a maximum distance on a virtual color wheel from both the first color and the initial second color. The system then generates a color mixture based on the first color and the second color. The color mixture can be displayed in the user interface, such as in the background portion of the user interface. The second color can be displayed about the index finger touch point. The user may adjust the weighting of each color in the color mixing by moving the touch points relative to each other.

Generally, in one aspect, a system for color selection is provided. The system can include a gesture receiver. The gesture receiver can be configured to receive a first touch point from a user interface. The first touch point can have a first initial location and a first current location. According to an example, the first touch point can further have a first pressure.

The gesture receiver can be further configured to receive a second touch point from the user interface. The second touch point can have a second initial location and a second current location. According to an example, the second touch point can further have a second pressure.

According to an example, the user interface is displayed on a touchscreen. The first touch point can correspond to a user touching the touchscreen with a first finger. The second touch point can correspond to the user touching the touchscreen with a second finger while the first finger remains in contact with the touchscreen.

The system can further include a color generator. The color generator can be configured to generate a first color. According to an example, the color generator can be configured to generate the first color based on a random color generator. According to a further example, the color generator can be configured to generate the first color based on the first initial location. According to an example, the user interface can be configured to display the first color about the first touch point.

The color generator can be further configured to generate a second color. According to an example, the second color can be based on the first color and a color optimizer. According to a further example, the color generator can be configured to generate the first color based on a random color generator. According to an example, the user interface can be configured to display the second color about the second touch point.

The system can further include a color mixer configured to generate a mixed color. The mixed color can be based on the first color, the second color, the first initial location, the first current location, the second initial location, and the second current location. According to an example, the color mixer can be configured to generate the mixed color further based on the first pressure and the second pressure.

According to an example, the user interface can be configured to display the mixed color. The mixed color can be displayed in a background portion of the user interface.

Generally, in another aspect, a method for color selection is provided. The method can include receiving, via a gesture receiver, a first touch point from a user interface, wherein the first touch point has a first initial location and a first current location. The method can further include generating, via a color generator, a first color. The method can further include receiving, via the gesture receiver, a second touch point from the user interface, wherein the second touch point has a second initial location and a second current location. The method can further include generating, via the color generator, a second color based on the first color and a color optimizer. The method can further include generating, via the color mixer, a mixed color based on the first color, the second color, the first initial location, the first current location, the second initial location, and the second current location.

According to an example, the method can further include displaying, via the user interface, the first color about the first touch point. The method can further include displaying, via the user interface, the second color about the second touch point. The method can further include displaying, via the user interface, the mixed color in a background portion of the user interface. According to an example, the method can further include displaying, via a touchscreen, the user interface.

In various implementations, a processor or controller can be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a top-level block diagram of a system for color selection, in accordance with an example.

FIG. 2 is a schematic diagram of a system for color selection, in accordance with an example.

FIG. 3 is an illustration of a system for color selection, in accordance with an example.

FIG. 4 is a further illustration of a system for color selection, in accordance with an example.

FIG. 5 is an illustration of optimized color generation via a virtual color wheel, in accordance with an example.

FIG. 6 is a method for color mixing, in accordance with an example.

### DETAILED DESCRIPTION OF EMBODIMENTS

The present disclosure is directed generally to systems and methods for color selection. More particularly, the systems and methods can be implemented in the context of an interactive lighting system of an architectural structure, such as a building, façade, bridge, or monument. The interactive lighting system can control the color emitted by a plurality of dynamic color changing LEDs.

The user may select the color to be emitted via a user interface. The user interface is displayed on a touchscreen, such as a touchscreen of a smartphone, tablet computer, or kiosk computer. The user begins the color selection process by touching the user interface with one of their fingers, such as their thumb. The system generates a first color, which is displayed on the user interface. The first color can be generated randomly, or it can be generated based on the location of the thumb touch point. The first color can be displayed in the user interface, such as about the thumb touch point or in a background portion of the user interface. The user may adjust the intensity of the chosen color by the amount of pressure applied to the thumb touch point, and these intensity adjustments can be reflected in the display of the first color. The user may generate an entirely different first color by lifting their thumb from the user interface, and touching the user interface a second time.

The user continues the color selection process by touching the user interface with a second finger, such as their index finger, while their first finger remains in contact with the user interface. The system generates a second color based on a color optimizer. The color optimizer chooses the second color such that it would be a maximum distance from the first color on a virtual color wheel. The user may generate a different second color by lifting their index finger from the user interface, and touching the user interface a second time. The new second color will be a maximum distance on a virtual color wheel from both the first color and the initial second color.

The system then generates a color mixture based on the first color and the second color. The color mixture can be displayed in the user interface, such as in the background portion of the user interface. The second color can be displayed about the index finger touch point. The user may adjust the weighting of each color in the color mixing by moving the touch points relative to each other. Once the user is satisfied with the color mixture, the user interface can receive an indication to program the LEDs of the interactive system to emit a color matching the color mixture. The indication can be provided in the form of a swiping motion. The randomness and playfulness of the color generation and color mixture processes will enhance user engagement, while still granting the user a significant degree of control over the color selection process.

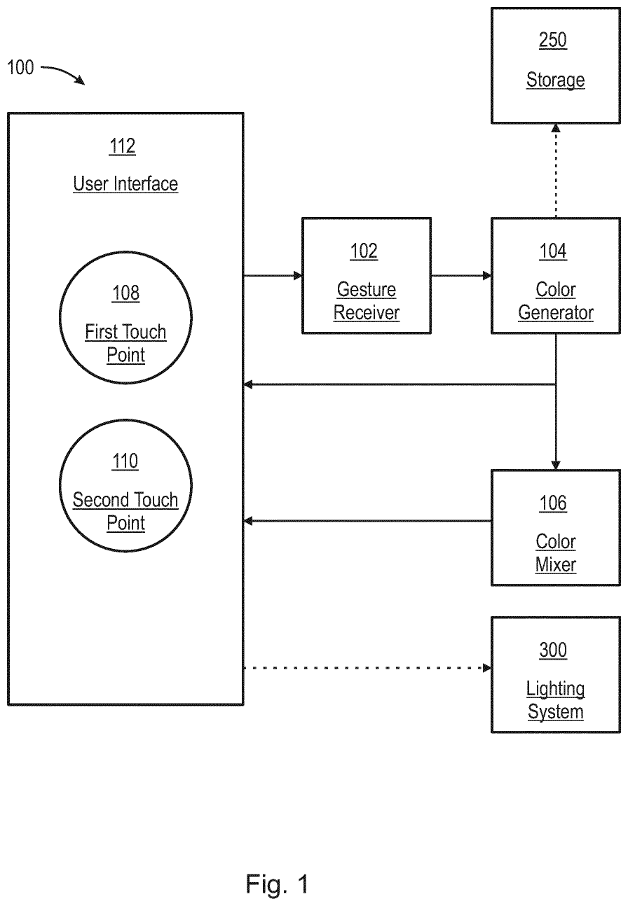

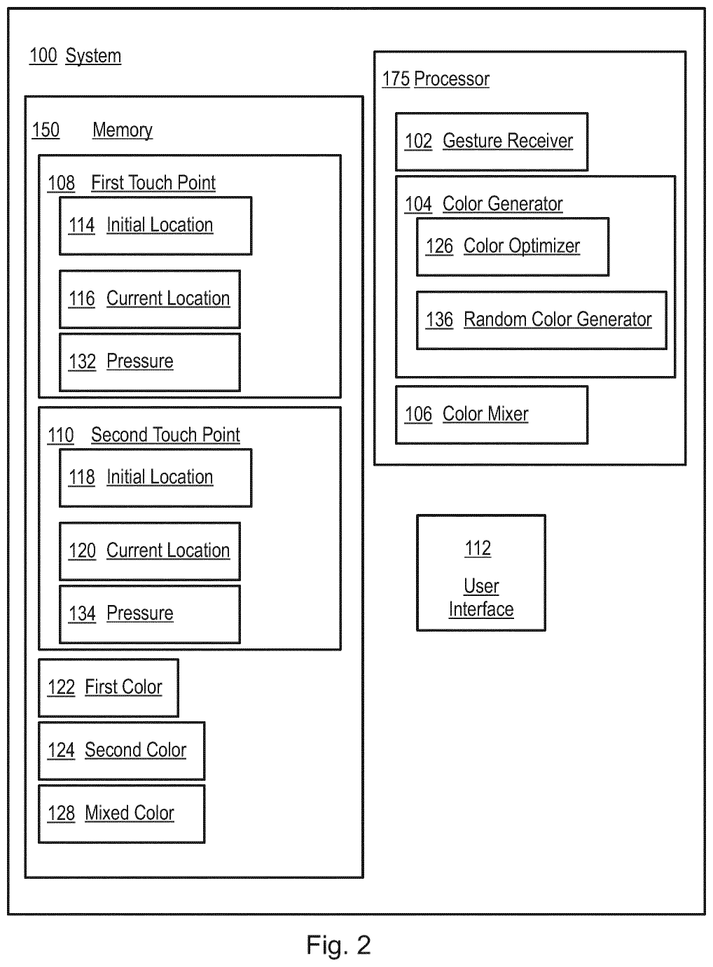

Generally, in one aspect, and with reference to FIGS. 1 and 2, a system 100 for color selection is provided. As shown in FIG. 1, the system 100 can include a gesture receiver 102, a color generator 104, a color mixer 106, and a user interface 112. In some examples, the system 100 can further include storage 250 for storing the colors generated by the color generator 104. The system 100 can be part of a computing device, such as a smartphone, tablet computer, desktop computer, kiosk computer, etc. As part of the computing device, the system 100 can include, or have access to, memory 150 and processor 175. The system 100 can be used to program a color or color scheme for a lighting system 300, such as lighting for a building, façade, or monument.

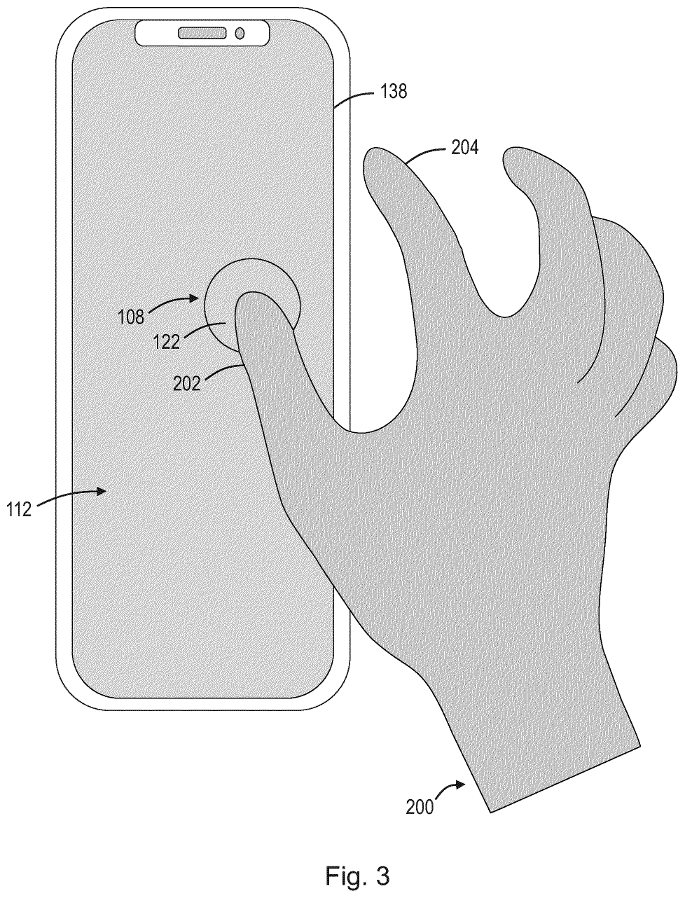

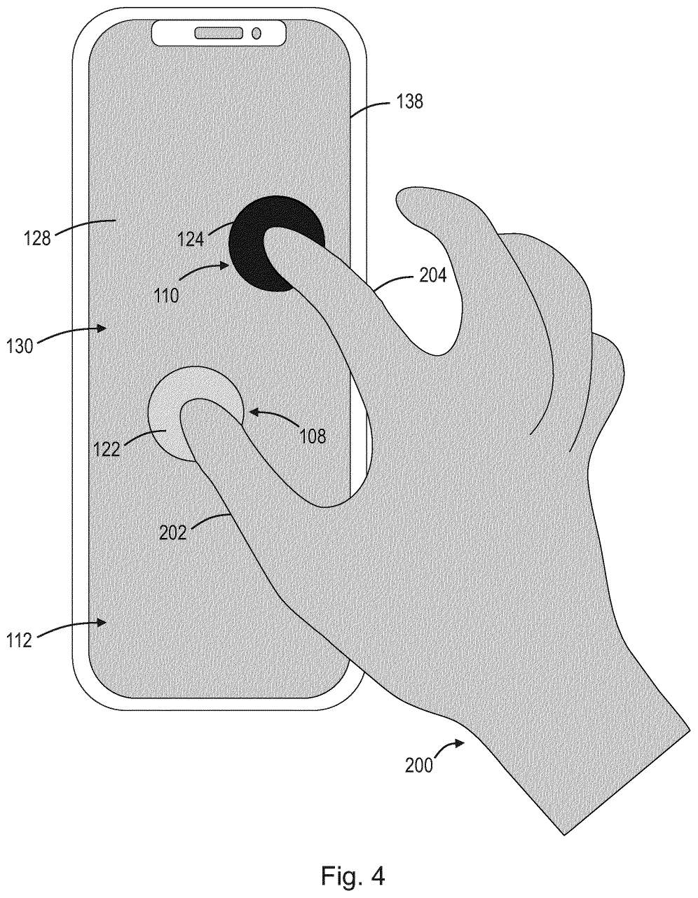

As shown in FIGS. 3 and 4, a user can interact with the user interface 112 via touchscreen 138. The touchscreen 138 can be part of the aforementioned computing device, such as the touchscreen 138 of a smartphone or kiosk computer. The touchscreen 138 can be capable of capturing the location of a touch point, as well as the pressure applied at the touch point. The touchscreen 138 can be further capable of following a finger of the user as it drags a touch point around the user interface 112. The touchscreen 138 can be further capable of detecting a swiping motion or similar motions.

As shown in FIGS. 3 and 4, the touchscreen 138 can display the user interface 112. The user interface 112 can interact with the user 200 to prompt the user to touch the touchscreen 138, display the colors generated and mixed by the system 100, and convey information regarding touch points to the gesture receiver 102. When the system 100 initializes, the user interface 112 can prompt the user 200 to touch the touchscreen 138 with a first finger 202. The prompt can be a text message, a color pattern, or any other type of prompt displayed in the user interface 112. In a further example, the computing device can generate a voice command to prompt the user.

As shown in FIG. 3, the user interface 112 then displays the first color 122 generated by the system 100 about the first finger 202 of the user 200. In FIG. 3, the first color 122 displayed in a circle about the first finger 202. In further examples, the first color 122 can be displayed in other shapes or sizes as appropriate. The first color 122 can also be displayed in the background portion 130 of the user interface 130. Alternatively, the background portion 130 can display a standard background color (such as black) until two colors are generated and mixed. The user 200 may generate a new first color 122 by removing their first finger 202 from the touchscreen 138, and then touching the touchscreen 138 again. Further, the user may adjust the first color 122 by applying more or less pressure to the touchscreen 138 at the first touch point 108.

The user interface 112 can then prompt the user 200 to touch the touchscreen 138 with a second finger 204 while the first finger 202 remains in contact with the touchscreen 138. As shown in FIG. 4, the user interface then displays the second color 124 about the second finger 204 of the user 200. Further, a mixed color 128, a mixture of the first 122 and second 124 colors, can be displayed in the background portion 130 of the user interface 112. The user 200 may adjust the mixed color 128 by moving the first 202 and second 204 fingers relative to each other, as well as adjusting the pressure applied by each finger 202, 204. Once the user 200 is satisfied with the mixed color 128, the user 200 may indicate their satisfaction via a swiping motion or other motion or input. The mixed color 128 can then be provided to lighting system 300 to program the color or color scheme of the lighting system 300.

With reference to FIGS. 1 and 2, the system 100 can include a gesture receiver 102. Generally, the gesture receiver 102 receives touchpoints 108, 110 from the user 200 on the user interface 112 via the touchscreen 138. The touchpoints 108, 110 include location information regarding placement of the touchpoint 108, 110 in the user interface 112. The touchpoints 108, 110 also include pressure information regarding the pressure applied by the user 200 at each touchpoint 108, 110.

The gesture receiver 102 can be configured to receive a first touch point 108 from a user interface 112. As shown in FIG. 3, the first touch point 108 is where the thumb 202 of the user 200 touches the user interface 112 displayed on the touchscreen 138. The first touch point 108 can have a first initial location 114 and a first current location 116. Tracking the current location 116 of the first touch point 108 allows the user to control the weight of the touch points 108, 110 during color mixing. Further, according to an example, the first touch point 108 can have a first pressure 132.

The system 100 can further include a color generator 104. As shown in FIG. 1, the gesture receiver 102 alerts the color generator 104 that the user 200 has touched the touchscreen 138 with a first finger 202, resulting in a first touch point 108 on the user interface 112. The gesture receiver 102 can also pass on initial location information 114 for the first touch point 108 to the color generator 104. The color generator 104 can store each color it generates in storage 250 for future reference.

Upon being alerted of the existence of the first touch point 108, the color generator 104 can be configured to generate a first color 122. The first color 122 can be generated in a number of different ways. In a first example, the color generator 104 can be configured to generate the first color 122 based on a random color generator 136. The random color generator 136 can select the first color 122 based on Equation 1:

$${x}_{i}^{m} = [ \begin{matrix}{R}_{i} \\ {G}_{i} \\ {B}_{i}\end{matrix} ] \qquad ( 1 )$$

where i is the touch point iteration (i.e., the number of times this finger has touched the screen), m is the touch point (first or second), Rᵢ is a random amount of red, Gᵢ is a random amount of green, and Bᵢ is a random amount of blue.

According to a further example, the color generator 104 can be configured to generate the first color 122 based on the first initial location 114. In this example, different portions of the user interface 112 can reference different portions of the color wheel; the upper right can represent different shades of blue, the lower left can represent different shades of red, etc.

As shown in FIG. 3, once the first color 122 is generated, the user interface 112 displays the first color 122 about the first touch point 110. The amount and/or shape of the first color 122 displayed can be proportional to the pixel size of the user interface 112. For example, the first color 122 can be displayed in a much bigger circle on a kiosk computer than a smartphone.

The gesture receiver 102 can be further configured to receive a second touch point 110 from the user interface 112. The second touch point 110 can correspond to the user 200 touching the touchscreen 138 with a second finger 204 while the first finger 202 remains in contact with the touchscreen 138. In a further example, the second finger 204 can be from a different hand, or even a different user than the first finger 202. In this example, two users may be able to control the system 100 by working together to generate the colors 122, 124 and adjust the mixing properties of the mixed color 128.

Similar to the first touch point 108, the second touch point 110 can have a second initial location 118 and a second current location 120. According to an example, the second touch point 110 can further have a second pressure 134.

The color generator 104 can be further configured to generate a second color 124. According to an example, and as shown in FIG. 4, the user interface 112 can be configured to display the second color 124 about the second touch point 110. While the first color 122 was generated based on the random color generator 136 or the first initial location 114, the second color 124 is generated based on the first color 122 and a color optimizer 126.

The color optimizer 126 determines a second color 124 as different as possible from the first color 122. This “difference” can be represented as the distance between two colors on a virtual color wheel; the color optimizer 126 selects the second color 124 as the color the farthest distance from the first color 122 on a virtual color wheel. Further, if the user 200 dislikes the initially chosen second color 124a, the next second color 124b presented to the user 200 can be the color the farthest distance from both the first color 122 and the initially chosen second color 124.

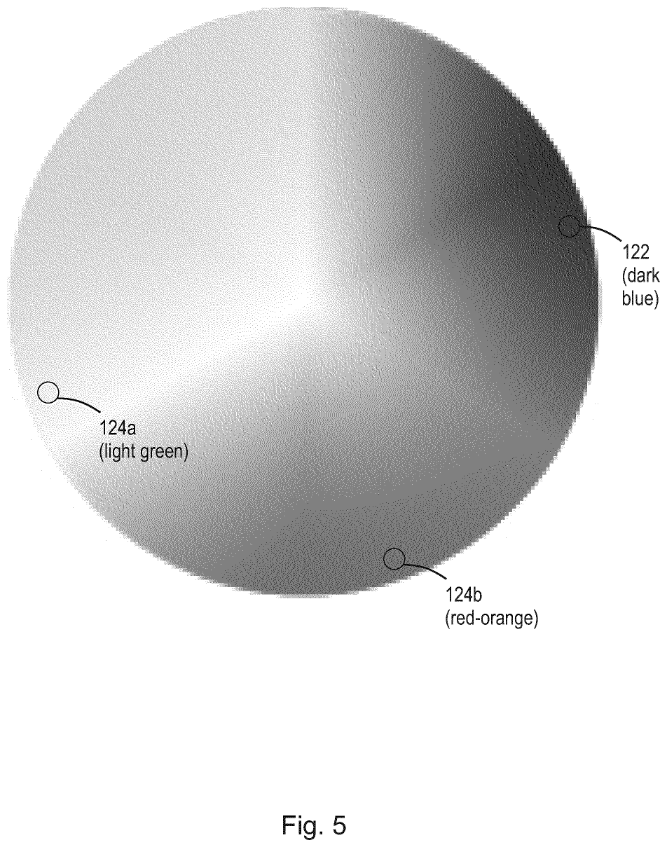

An example virtual color wheel is shown in FIG. 5. As depicted on the color wheel, the color generator 104 generates the first color 122 as dark blue. This first color 122 can be chosen randomly. The color generator 104 then generates, via the color optimizer 126, an initially chosen second color 124a as light green. As shown in FIG. 5, this light green is the color the farthest distance from the dark blue of the first color 122. If the user 200 wishes to choose a different second color 124, the color generator 104 then generates, again via the color optimizer 126, the next second color 124b as red-orange. The color generator 104 can continue to generate second colors 124 which are the farthest total distance from the previously generated colors until the user is satisfied. Accordingly, the color optimizer 126 can determine the second color 124 based on Equations 2a-2c:

$${x}_{i}^{m} = arg {max}_{x} {\sum }_{m} {\sum }_{k = 1}^{i - 1} {( x - {x}_{k}^{m} )}^{2} \qquad ( 2 a )$$

$$such that x , {x}_{k} ∈ {3}^{} \& x ∈ {[ 0 , 255 ]}^{3} \qquad ( 2 b )$$

$$m ∈ \{ active touch points \} \qquad ( 2 c )$$

In Equation 2b, [symbol] ³ represents three-dimensional space, and each value of x is a three-dimensional vector with [R, B, G] values.

In an alternate example, the second color 124 can be generated independently of the first color 122, rather than based on the color optimizer 126 and the first color 122. In this example, the initial second color 124 can be generated via the random color generator 136 or based on the second initial location 118. If the user desires a new second color, the new second color can be generated using the color optimizer 126 such that the new second color is as different as possible from the initially chosen second color 122.

The system 100 can further include a color mixer 106. As shown in FIG. 1, the color mixer 106 receives the first 122 and second 124 colors from the color generator 104. The color mixer 106 then generates a mixed color 106, and provides the mixed color 112 to the user interface 122. The mixed color 128 can be displayed in a background portion 130 of the user interface 112.

The mixed color 128 can be based on the first color 122, the second color 124, the first initial location 114, the first current location 116, the second initial location 118, and the second current location 120. For example, the weighting of each color 122, 124 in the color mixing process can depend on the motion of the first 108 and second 110 touch points relative to each other. This movement can be determined by comparing the first 116 and second 120 current locations with the first 114 and second 118 initial locations. For example, if the first touch point 108 is determined to be moving towards the second touch point 110, the first color 122 can be weighted more heavily than the second color 124. Similarly, if the first touch point 108 is determined to be moving away from the second touch point 110, the second color 124 can be weighted more heavily.

According to an example, the color mixer 106 can be configured to generate the mixed color 128 further based on the first pressure 132 and the second pressure 134. The user 200 may adjust the intensity of the first 122 and second 124 color by the amount of pressure applied to the touch points 108, 110. For example, a lighter touch at the first touch point 108 can result in the display of a less intense (lighter) variation of the first color 122 displayed in the user interface 112. In a further example, a heavier touch at the second touch point 110 can result in the display of a more intense (darker) variation of the second color 122 displayed in the user interface 112. The color mixer 106 can then utilize these color variations in the mixing process to generate the mixed color 128.

Once the mixed color 128 has been generated by the color mixer 106 and displayed on the user interface 112, the user 200 may continue to adjust the mixed color in a number of ways. For example, the user can lift one or both of their fingers 202, 204 to generate an entirely new first color 122 and/or second color 124. The user may adjust the intensity of the colors 122, 124 by applying more or less pressure to the corresponding touch points 108. The user may adjust the weight of each color 122, 124 in the mixture by moving the touch points 108, 110 relative to each other.

If the user 200 is satisfied by the mixed color 128 generated by the color mixer 106 and displayed in the user interface 112, they may indicate their satisfaction via a swiping motion. Upon receiving the swiping motion, the user interface 112 can convey the mixed color 128 to the lighting system 300, such that the lighting system 300 will display the mixed color 128 as part of their color scheme. The user 200 may indicate their satisfaction through a variety of other means, such as by speaking a voice command, holding the mixed color 128 constant for a predefined time duration, lifting both the first finger 202 and second finger 204 off the touchscreen 138 simultaneously, tapping the touchscreen 138 with a third finger, etc.

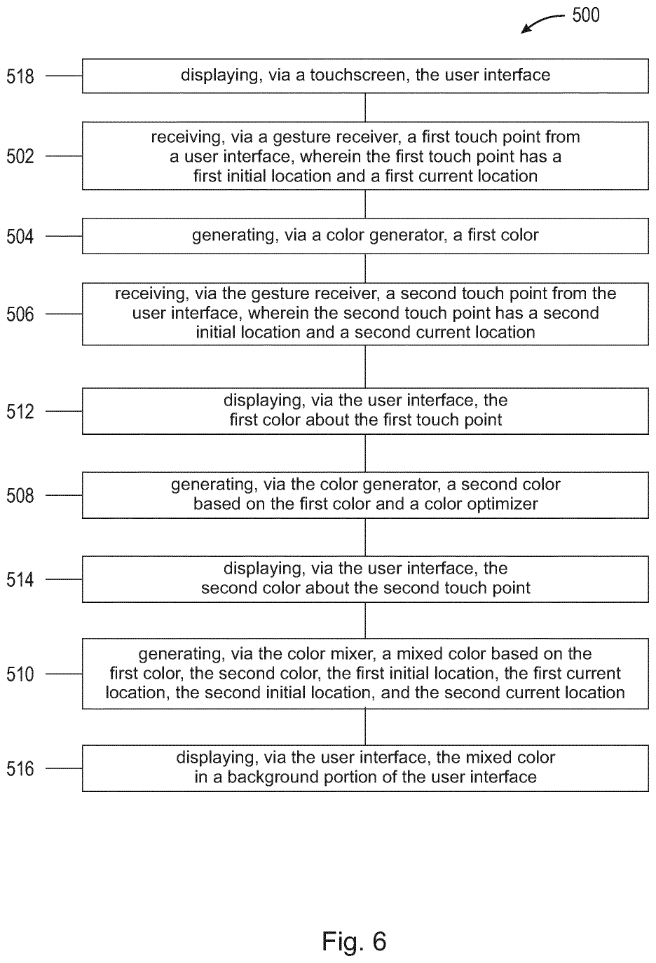

Generally, in another aspect, and with reference to FIG. 6, a method 500 for color selection is provided. The method 500 can include receiving 502, via a gesture receiver, a first touch point from a user interface, wherein the first touch point has a first initial location and a first current location. The method 500 can further include generating 504, via a color generator, a first color. The method 500 can further include receiving 506, via the gesture receiver, a second touch point from the user interface, wherein the second touch point has a second initial location and a second current location The method 500 can further include generating 508, via the color generator, a second color based on the first color and a color optimizer. The method 500 can further include generating 510, via the color mixer, a mixed color based on the first color, the second color, the first initial location, the first current location, the second initial location, and the second current location.

According to an example, the method 500 can further include displaying 512, via the user interface, the first color about the first touch point. The method 500 can further include displaying 514, via the user interface, the second color about the second touch point. The method 500 can further include displaying 516, via the user interface, the mixed color in a background portion of the user interface.

According to an example, the method 500 can further include displaying 518, via a touchscreen, the user interface.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A system for color selection for an interactive lighting system, comprising:
a gesture receiver configured to:
receive a first touch point from a user interface, wherein the first touch point has a first initial location and a first current location; and
receive a second touch point from the user interface, wherein the second touch point has a second initial location and a second current location;
a color generator configured to:
generate a first color responsive to receiving the first touch point; and
generate a second color responsive to receiving the second touch point; and
a color mixer configured to generate a mixed color to be emitted by one or more light emitting diodes (LEDs) of the interactive lighting system, wherein the mixed color is based on the first color, the second color, the first initial location, the first current location, the second initial location, and the second current location.

2. The system for color selection of claim 1, wherein the user interface is configured to display the mixed color.

3. The system for color selection of claim 2, wherein the mixed color is displayed in a background portion of the user interface.

4. The system for color selection of claim 1, wherein the user interface is configured to display the first color about the first touch point, and wherein the user interface is configured to display the second color about the second touch point.

5. The system for color selection of claim 1, wherein the first touch point further has a first pressure, and wherein the second touch point further has a second pressure.

6. The system for color selection of claim 5, wherein the color mixer is configured to generate the mixed color further based on the first pressure and the second pressure.

7. The system for color selection of claim 1, wherein the color generator is configured to generate the first color based on a random color generator.

8. The system for color selection of claim 1, wherein the color generator is configured to generate the first color based on the first initial location.

9. The system for color selection of claim 1, wherein the color generator is configured to generate the second color based on a random color generator.

10. The system for color selection of claim 1, wherein the color generator is configured to generate the second color based on the first color and a color optimizer.

11. The system for color selection of claim 1, wherein the user interface is displayed on a touchscreen.

12. The system for color selection of claim 10, wherein the first touch point corresponds to a user touching the touchscreen with a first finger, and wherein the second touch point corresponds to the user touching the touchscreen with a second finger while the first finger remains in contact with the touchscreen.

13. A method for color selection for an interactive lighting system, comprising:
receiving, via a gesture receiver, a first touch point from a user interface, wherein the first touch point has a first initial location and a first current location;
generating, via a color generator, a first color responsive to receiving the first touch point;
receiving, via the gesture receiver, a second touch point from the user interface, wherein the second touch point has a second initial location and a second current location;
generating, via the color generator, a second color responsive to receiving the second touch point, wherein the second color is based on the first color and a color optimizer; and
generating, via the color mixer, a mixed color to be emitted by one or more light emitting diodes (LEDs) of the interactive lighting system, wherein the mixed color is based on the first color, the second color, the first initial location, the first current location, the second initial location, and the second current location.

14. The method of claim 13, further comprising:
displaying, via the user interface, the first color about the first touch point;
displaying, via the user interface, the second color about the second touch point; and
displaying, via the user interface, the mixed color in a background portion of the user interface.

15. The method of claim 13, further comprising displaying, via a touchscreen, the user interface.
